(19) United States
(12) Patent Application Publication
(10) Pub. No.: US 2003/0185168 A1
(43) Pub. Date: Oct. 2, 2003

(54) Topology of frequency converting blocks of wireless lan access point

(76) Inventor: Yu-Wei Tung, Pateh City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/107,071

(22) Filed: Mar. 28, 2002

(51) Int. Cl. H04Q 7/00

(52) U.S. Cl. 370/329; 370/419

(57) ABSTRACT

The present invention relates to a new topology of frequency converting blocks of wireless LAN access point which consists of an indoor unit and an outdoor unit. The indoor unit includes an access point in connection with the indoor wired network through a network cable, a down converter reducing radio frequency outputted by the access point to intermediate frequency and a DC injector used to connect intermediate frequency IF with the DC power. The outdoor unit includes an up converter connected with the output interface of the DC injector by a coaxial cable and used to lift intermediate frequency IF to radio frequency RF and a booster boosting radio frequency RF of the up converter for output. Accordingly, the present invention can enlarge the operational temperature range, the application scope and reduce the cost thereof.

### BACKGROUND OF THE INVENTION

1. Field of the Invention

The present invention relates to a new topology of frequency converting blocks of wireless LAN access point, and more particularly, to a system through which radio frequency of the indoor access point is converted into intermediate frequency which is transmitted to the outside and converted back into radio frequency for output.

2. Description of the Prior Art

The wireless local area network is the tendency and the demand for mobile offices and is applied to the area where the connection is uneasily achieved. According to the IEEE802.11b standard, the ISM (industrial, scientific and medical) band—2.4 GHz—whose use doesn't require license so that the cable restriction can be removed. The wireless local area network has the advantages of easy installation, high mobility, wide coverage, penetration of partition and being safe and secret. Accordingly, the wireless local area network is the extension of the local area wired network. Even, the former will replace the latter.

In the wireless local area network, access points are necessary to reach the network connection. Thus, the access point corresponds to the hub of the wired network. The easiest connection of the wireless local area network (for example, between buildings) can be fulfilled by means that the access point is fitted outdoors at a place of higher position to reduce the blockage. Besides, an outdoor box is installed to protect the access point. However, the common access point is made by commercially available components and designed mainly for the indoor use. Therefore, its operational temperature is from 0° C. to 60° C. If the outdoor temperature is under 0° C., the way to directly install the access point outdoors is no more applicable. (To use the industrial outdoor access point, the cost is too high.). Therefore, the access point can only be placed indoors while the antenna is fitted outside to connect therewith. However, it is to note that the antenna cable has to be as short as possible to avoid the signal loss since the signal intensity decreases when the cable length increases. So, the solution with the antenna has the disadvantage of being restricted by the installation distance.

### SUMMARY OF THE INVENTION

It is a primary object of the present invention to provide a new topology of frequency converting blocks of wireless LAN access point in which a down converter reduces radio frequency outputted by the access point to intermediate frequency which is connected to a DC power through a DC injector. Thereafter, intermediate frequency IF is fed into an outdoor up converter for lifting the frequency and being outputted by means of a booster. Accordingly, the present invention can enlarge the operational temperature range, the application scope and reduce the cost thereof.

It is another object of the present invention to provide a new topology of frequency converting blocks of wireless LAN access point in which a power divider can be interposed between the access point and the down converter in order to divide the power for indoor network through an output interface.

It is a further object of the present invention to provide a new topology of frequency converting blocks of wireless LAN access point in which a bandwidth management is provided in front of the access point, thereby performing the quality management of network service to enhance the network efficiency.

### BRIEF DESCRIPTION OF THE DRAWINGS

The accomplishment of this and other objects of the invention will become apparent from the following description and its accompanying drawings of which:

FIG. 1 is a block diagram of the system structure of an applicable embodiment of the present invention; and

FIG. 2 is a block diagram of the system structure of another applicable embodiment of the present invention.

### DETAILED DESCRIPTION OF THE PREFERRED EMBODIMENT

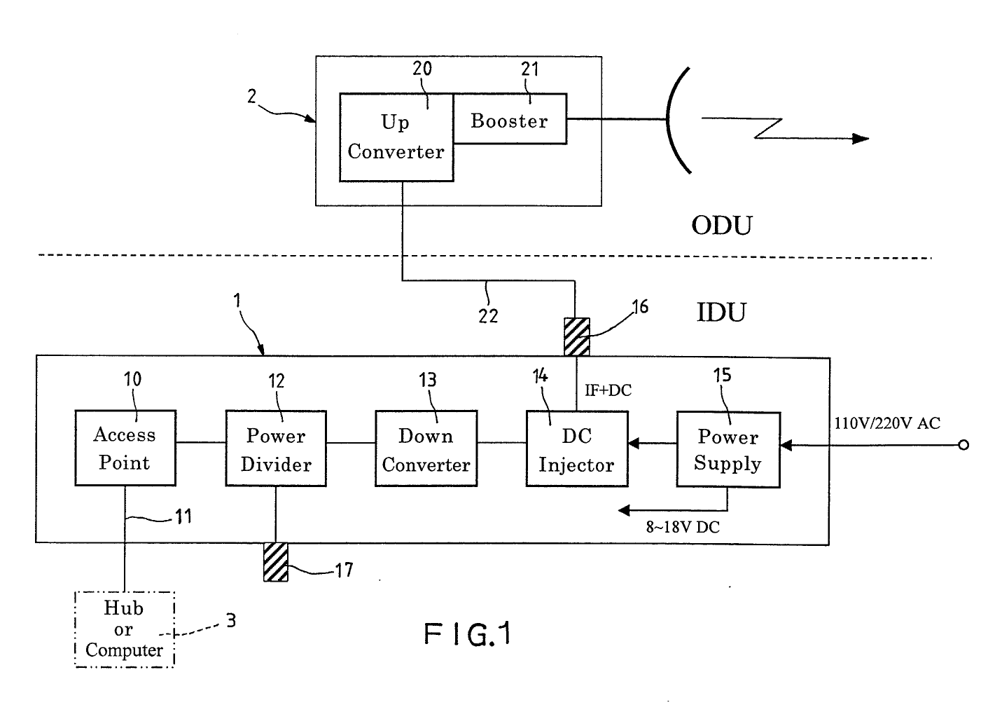

First of all, referring to FIG. 1, the present invention consist of an indoor unit (IDU) and an outdoor unit (ODU). The indoor unit includes an access point 10, a down converter 13 and a DC injector 14. The access point 10 is in connection with a hub or a computer of the indoor wired network through a network cable 11. The network cable 11 of the applicable embodiment of the present invention is of RJ45-specification. The down converter 13 is used to reduce radio frequency outputted by the access point 10 to intermediate frequency. Intermediate frequency IF amounts to 100-1500 MHz or higher. The DC injector 14 is connected with the down converter 13 at one end and with a power supply 15 at the other end thereof. The DC injector 14 is used to connect intermediate frequency IF with the DC power to an output interface 16. The output interface 16 is an F type connector. The power supply 15 converts AC power into DC power (e.g. 8-18V of preset voltage). In addition to supplying power to the DC injector 14, the power supply 15 provides all components of the indoor unit with required power.

The outdoor unit includes an up converter 20 and a booster 21. The up converter 20 is connected with the output interface 16 of the DC injector 14 by a coaxial cable 22 in order to lift intermediate frequency IF to radio frequency RF. The booster 21 boosts radio frequency RF of the up converter 20 for output.

Moreover, a power divider can be interposed between the access point 10 and the down converter 13 in order to divide the power for indoor network through an output interface 17. The output interface 17 can be a SMA-connector and is at user's disposal to carry out test indoors.

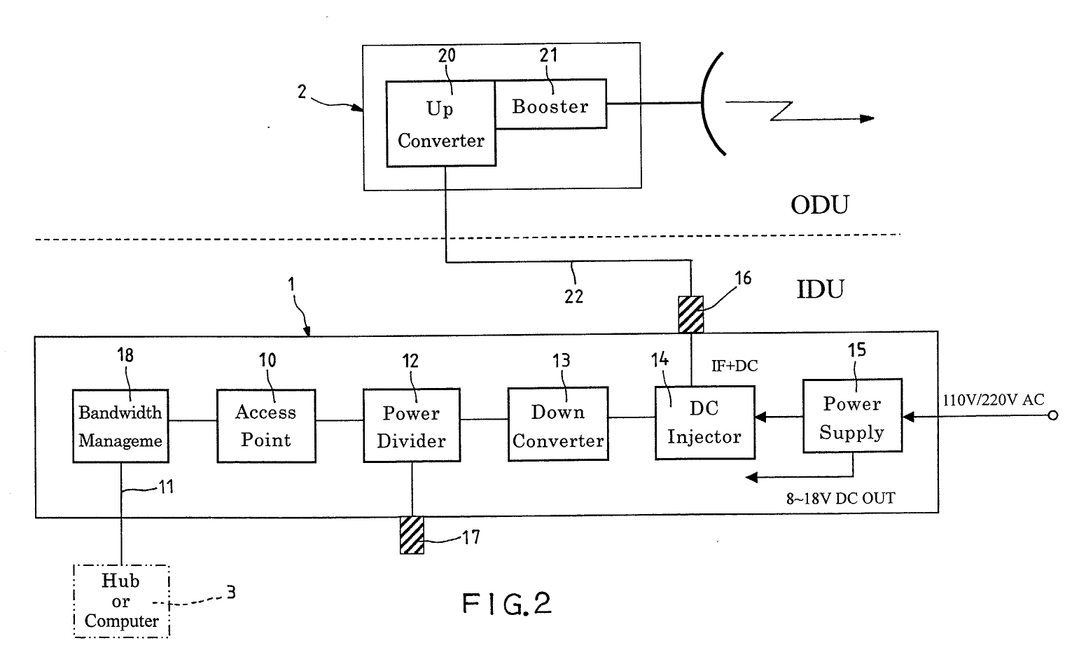

Furthermore, as shown in FIG. 2, another applicable embodiment of the present invention is provided with a bandwidth management 18 in front of the access point 10. The bandwidth management 18 is in connection with a hub or a computer of the indoor wired network through a network cable 11. Accordingly, quality management of network service can be performed to enhance the network efficiency.

The above-mentioned component of the indoor unit can be pre-assembled in a housing to be an assembly unit 1. The up converter 20 and the booster 21 of the outdoor unit can be assembled to be anther assembly unit 2. The assembly units 1 and 2 are able to facilitate the installation.

Based upon the above-mentioned, the present invention can be applied to two situations as follows:

1. −40˜80° C. of the outdoor temperature: Most of the access points can only be applied to the temperature between 0˜60° C., and the industrial outdoor access points are very expensive. However, the access point 10 and the power supply of the present invention are placed indoors, and a synchronic transmission can be reached by the coaxial cable 22. To the contrary, the up converter 20 and the booster 21 are placed outdoors. Therefore, the problem with the limited temperature range is resolved. Besides, you don't have to worry about how to supply the outdoor components with power.

2. A great distance between the indoor and outdoor units: The present invention reduces radio frequency RF outputted by the access point 10 to intermediate frequency IF. Thus, the use of the expensive radio frequency RF cable can be avoided. Meanwhile, the signal loss of the IF cable is slighter so that the distance between the indoor and outdoor units can amount to 150 m.

Since intermediate frequency IF and the DC power supply are combined by the DC injector 14 so that only one coaxial cable 22 is required between the indoor and outdoor units. Intermediate frequency IF can be converted by the up converter 20 to any other frequency, thereby adjusting to different countries and areas with different frequency requirement. The system of the present invention is applicable to IEEE802.11b, IEEE802.11a, or even the future IEEE802.11g, Hiper LAN/2 and IEEE802.16. Accordingly, the present invention can enlarge the operational temperature range, the application scope and reduce the cost thereof.

Many changes and modifications in the above-described embodiments of the invention can, of course, be carried out without departing from the scope thereof. Accordingly, to promote the progress in science and the useful arts, the invention is disclosed and is intended to be limited only by the scope of the appended claims.

What is claimed is:

1. A new topology of frequency converting blocks of wireless LAN access point comprising an indoor unit and an outdoor unit;
wherein the improvement is characterized by:
said indoor unit having an access point in connection with the indoor wired network through a network cable, a down converter reducing radio frequency RF outputted by said access point to intermediate frequency IF and a DC injector connected with said down converter and a power supply while said DC injector is used to connect intermediate frequency IF with DC power to an output interface; and
said outdoor unit having an up converter connected with said output interface of said DC injector by a coaxial cable and used to lift intermediate frequency IF to radio frequency RF and a booster boosting radio frequency RF of said up converter for output.

2. The new topology of frequency converting blocks of wireless LAN access point as claimed in claim 1, wherein a power divider can be interposed between said access point and said down converter in order to divide the power for indoor network through an output interface.

3. The new topology of frequency converting blocks of wireless LAN access point as claimed in claim 1, wherein a bandwidth management is provided with in front of said access point.
